(19) United States
(12) Patent Application Publication
(10) Pub. No.: US 2010/0022174 A1
(43) Pub. Date: Jan. 28, 2010

(54) Grinding tool and method for fabricating the same

(75) Inventors: Jui-Lin Chou, Ji-an Township (TW); Tung-liang Liao, Jhongli City (TW); Yung-Chuan Chen, Taitung City (TW)

Correspondence Address: BACON & THOMAS, PLLC, 625 SLATERS LANE, FOURTH FLOOR, ALEXANDRIA, VA, 22314-1176, US

(73) Assignee: Kinik Company, Taipei (TW)

(21) Appl. No.: 12/219,710

(22) Filed: Jul. 28, 2008

(51) Int. Cl. B23F 21/02; B24D 11/00

(52) U.S. Cl. 451/548; 51/295

(57) ABSTRACT

The present invention relates to a grinding tool and a method for fabricating the same. The method comprises: (A) providing a grinding plate having a working surface and a non-working surface, a mold having an adjustment surface, and a backplane; (B) getting the working surface of the grinding plate to fit precisely and be retained on the adjustment surface of the mold by a binder; (C) forming an adhesive layer on the non-working surface of the grinding plate; (D) disposing the backplane on a surface of the adhesive layer to retain the backplane over the non-working surface of the grinding plate by the adhesive layer; and (E) removing the binder to separate the mold from the grinding plate. Accordingly, the present invention can significantly improve the precision and lifetime of products, reduce the cost of production, and enhance the machining efficiency.

### BACKGROUND OF THE INVENTION

1. Field of the Invention

The present invention relates to a grinding tool and a method for fabricating the same and, more particularly, to a grinding tool and a method for fabricating the same that can improve the precision and lifetime of products, reduce the cost of production, and enhance the machining efficiency.

2. Description of Related Art

Grinding and polishing are ultra-precision machining technologies with the ability to make the surface of a workpiece have acceptable smoothness and flatness. Accordingly, grinding and polishing are widely used in precision machining of the surface of an object, such as hard and brittle metals, ceramics, glass and wafers. Thereby, it is an important issue to develop various grinding tools that can meet process requirements.

The manufacture and usage of grinding tools have been developed over many years. However, for conventional grinding tools, some disadvantages need to be improved, such as, the poor adhesion and non-uniform distribution of abrasive particles on a substrate. In a conventional method, a grinding tool is manufactured by sintering and brazing of materials like metals or ceramics. However, in such a high-temperature process, the substrate will suffer from heat deformation. Accordingly, it is necessary to use a material with low heat deformation characteristics as the substrate, and thereby the selection of the substrate becomes more difficult and the precision of the resultant grinding tool cannot be controlled well. However, if the abrasive particles are attached to the substrate by a binder, the precision of the working surface of the resultant product (such as flatness, convexity, and concavity) also cannot be controlled well due to the fluidity of the melted binder and the difference of shrinkage between the binder and the substrate. In addition, when the abrasive particles are attached to the substrate by a conventional method, the substrate cannot be recycled. Furthermore, the conventional grinding tool has a metallic working surface with -poor chemical resistance, and thereby the conventional grinding tool has a short lifetime.

FIGS. 1A and 1B show a conventional process for fabricating a grinding tool. As shown in FIG. 1A, a metal layer 120 is first formed on a working surface of a substrate 110, and a plurality of abrasive particles 130 is sprinkled on the surface of the metal layer 120. Subsequently, as shown in FIG. 1B, the metal layer 120 is melted by a high temperature treatment, and partial areas of the abrasive particles 130 will sink in the metal layer 120. Finally, the metal layer 120 is solidified by cooling, so that the abrasive particles 130 are retained on the metal layer 120 to form a grinding tool 100. However, in such a high temperature treatment, the substrate will suffer from heat deformation, and the degree of the abrasive particles being exposed cannot be controlled well. In addition, the substrate cannot be recycled and the metal layer has poor chemical resistance.

### SUMMARY OF THE INVENTION

An object of the present invention is to provide a grinding tool with improved precision, excellent chemical resistance, reduced fabrication cost and high machining efficiency.

To achieve the object, the present invention provides a grinding tool, comprising: a backplane; an adhesive layer disposed on a surface of the backplane; and a grinding plate disposed on a surface of the adhesive layer and having a working surface. Herein, the working surface of the grinding plate is exposed outside.

The grinding plate according to the present invention can comprise: a soft substrate having a working surface and a non-working surface; and a plurality of abrasive particles distributed over the working surface of the soft substrate. In addition, the abrasive particles can be further distributed over the non-working surface of the soft substrate. That is, the abrasive particles are distributed over the two surfaces of the soft substrate. Accordingly, the deformation resulting from the difference of shrinkage between the two surfaces can be inhibited. Herein, the abrasive particles can be directly formed on the surface of the soft substrate by brazing, sintering or electroplating. The abrasive particles can be any material with high hardness, such as aluminum oxide, silicon carbide or diamond. Preferably, the abrasive particles are diamond particles.

The grinding plate according to the present invention can further comprise: a combining layer disposed between the soft substrate and the abrasive particles to retain the abrasive particles over the soft substrate. The material of the combining layer can be a metallic material or a ceramic material, and the abrasive particles can be fixed over the soft substrate by sintering of metals or ceramic. In addition, the material of the combining layer also can be any material with binding ability, such as binders, to retain the abrasive particles over the soft substrate. The combining layer and the abrasive particles can be formed over the working surface of the soft substrate. Alternatively, the combining layer and the abrasive particles are formed over the working surface as well as the non-working surface of the soft substrate so as to inhibit the deformation resulting from the difference of shrinkage between the two surfaces of the soft substrate.

In the grinding tool according to the present invention, the material of the soft substrate can be any flexible material, so that the precision error can be reduced. Preferably, the material of the soft substrate is a metallic material or a plastic material.

In the grinding tool according to the present invention, the material of the backplane can be any material that can be easily machined and exhibit improved chemical resistance and be less remaining stress, such as stainless steel, so that the stability of the products can be enhanced.

In the grinding tool according to the present invention, preferably, the material of the adhesive layer is an epoxy resin. Accordingly, the adhesive layer can be cured by a heating process so as to retain the grinding plate over the backplane.

In the grinding tool according to the present invention, preferably, the thickness of the grinding plate is in a range of about 0.15 mm to 0.25 mm. In addition, preferably, the diameter of the abrasive particles is in a range of about 80 μm to 300 μm.

Another object of the present invention is to provide a method for fabricating the aforementioned grinding tool. By the method according to the present invention, the precision of the working surface of the grinding tool (such as flatness, convexity, and concavity) can be controlled well. In addition, the cost of production can be significantly reduced and the backplane can be recycled.

To achieve the object, the present invention provides a method for fabricating a grinding tool, comprising: (A) providing a grinding plate, a mold and a backplane, where the grinding plate has a working surface and a non-working surface and the mold has an adjustment surface; (B) getting the working surface of the grinding plate to fit precisely and be retained on the adjustment surface of the mold by a binder; (C) forming an adhesive layer on the non-working surface of the grinding plate; (D) retaining the backplane on a surface of the adhesive layer; and (E) removing the binder to separate the mold from the grinding plate. Herein, the grinding plate can be in the aforementioned structure.

In the method for fabricating a grinding tool according to the present invention, the binder can make the working surface of the grinding plate fit precisely and be retained on the adjustment surface of the mold by a heating process in the step (B). Accordingly, the curvature of the working surface of the grinding plate can accord with that of the adjustment surface of the mold. Herein, the grinding plate can fit precisely on the adjustment surface of the mold due to the flexibility of the grinding plate. Accordingly, the precision of the grinding plate can be controlled well and the height of the abrasive particles can be adjusted so as to ensure the performance of all abrasive particles in machining. Thereby, the machining efficiency of the working surface and precision can be significantly enhanced, so that the grinding tool according to the present invention is especially suitable for precision machining.

In the method for fabricating a grinding tool according to the present invention, the binder can be removed by a heating and cleaning process in the step (E) so as to separate the mold from the resultant grinding tool.

In the method for fabricating a grinding tool according to the present invention, preferably, the binder is wax.

In the method for fabricating a grinding tool according to the present invention, the selection of the backplane is not limited and the backplane can be any material that can be easily machined and exhibit improved chemical resistance and be less remaining stress instead of a common-used metallic material, so that the stability of the products can be enhanced. Preferably, the material of the backplane is stainless steel. In addition, the backplane can be retained separate from the grinding plate until necessary. Accordingly, the production lead time and the specifications can be reduced. Furthermore, the backplane can be separated from the grinding plate so as to be recycled, and thereby the cost of production can be reduced.

In the method for fabricating a grinding tool according to the present invention, the material of the soft substrate can be any flexible material, so that the precision errors can be reduced. Herein, preferably, the material of the soft substrate is a metallic material or a plastic material.

In the method for fabricating a grinding tool according to the present invention, the material of the abrasive particles can be any material with high hardness, such as aluminum oxide, silicon carbide or diamond. Preferably, the abrasive particles are diamond particles.

In the method for fabricating a grinding tool according to the present invention, preferably, the thickness of the grinding plate is in a range of about 0.15 mm to 0.25 mm. In addition, preferably, the diameter of the abrasive particles is in a range of about 80 μm to 300 μm.

Accordingly, by the method for fabricating a grinding tool according to the present invention, the height of the abrasive particles can be precisely controlled, and thereby each of the abrasive particles can efficiently perform machining so as to enhance the machining efficiency and precision of the grinding tool. Meanwhile, the method according to the present invention can resolve the matter of deformation due to the shrinkage differences. In addition, the method provided by the present invention can inhibit the precision errors caused by the thermal deformation of the backplane, and thus more kinds of materials can be used for the backplane. Preferably, the backplane is made of a material that can be easily machined and exhibit improved chemical resistance (such as stainless steel) and be less remaining stress instead of a common-used metallic material, so that the stability of the products can be enhanced. Furthermore, the backplane can be retained separate from the grinding plate until necessary. Accordingly, the production lead time and the specifications can be reduced. Besides, the backplane can be separated from the grinding plate so as to be recycled, and thereby the cost of production can be reduced.

### BRIEF DESCRIPTION OF THE DRAWINGS

FIGS. 1A and 1B show a conventional process for fabricating a grinding tool;

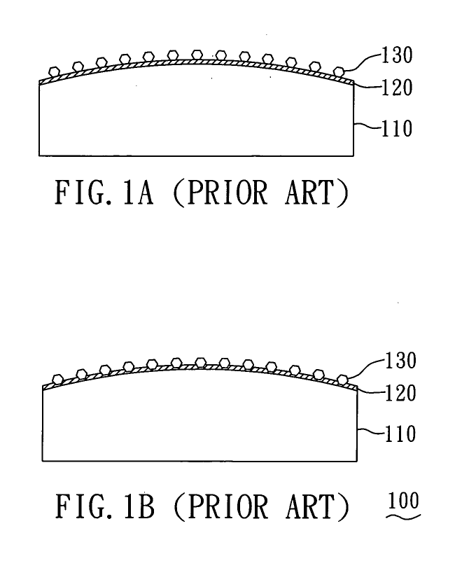

FIGS. 2A to 2D show a process for fabricating a grinding tool according to a preferred embodiment of the present invention;

FIGS. 3A to 3D show a process for fabricating a grinding tool according to a preferred embodiment of the present invention;

FIGS. 4A to 4D show a process for fabricating a grinding tool according to a preferred embodiment of the present invention; and

FIGS. 5A to 5D show a process for fabricating a grinding tool according to a preferred embodiment of the present invention.

### DETAILED DESCRIPTION OF THE PREFERRED EMBODIMENT

### Embodiment 1

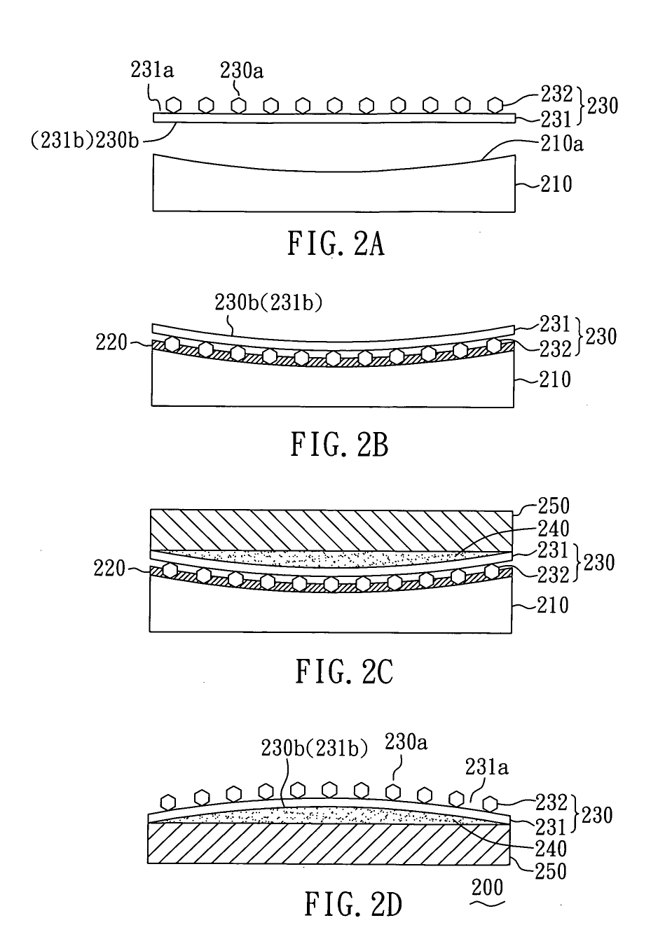

With reference to FIGS. 2A to 2D, there is shown a process for fabricating a grinding tool according to a preferred embodiment of the present invention.

As shown in FIG. 2A, a grinding plate 230 having a working surface 230a and a non-working surface 230b and a mold 210 with an adjustment surface 210a are first provided. Herein, the grinding plate 230 comprises: a soft substrate 231 having a working surface 231a and a non-working surface 231b and a plurality of abrasive particles 232 formed on the working surface 231a of the soft substrate 231 by brazing.

Subsequently, as shown in FIG. 2B, the adjustment surface of the mold 210 is coated with a binder 220, and then the working surface of the grinding plate 230 is attached and fits precisely on the adjustment surface of the mold 210, so that the abrasive particles 232 on the working surface of the grinding plate 230 can fit precisely on the adjustment surface of the mold 210. Next, the binder 220 is cured by a heating process (at a temperature of about 60° C.˜100° C.) to retain the grinding plate 230 on the mold 210 and ensure that the curvature of the working surface of the grinding plate 230 accords with that of the adjustment surface of the mold 210. Herein, the grinding plate 230 can fit precisely on the adjustment surface of the mold due to its flexibility so as to precisely control the precision of the grinding plate 230 and adjust the height of the abrasive particles 232. Accordingly, each of the abrasive particles 232 can efficiently perform machining so as to significantly enhance the machining efficiency and precision of the grinding tool and perform precision machining.

As shown in FIG. 2C, the non-working surface of the grinding plate 230 is coated with an adhesive layer 240 to form a flat surface. Then, a backplane 250 is disposed on the surface of the adhesive layer 240, and the adhesive layer 240 is cured by a heating process so as to retain the backplane 250 on the non-working surface of the grinding plate 230.

Finally, the binder is softened by a heating process (at a temperature of about 60° C.˜100° C.) and removed by washing to separate the mold 210 from the grinding plate 230. Accordingly, a grinding tool 200 is obtained, as shown in FIG. 2D.

In the present embodiment, the material of the backplane 250 is stainless steel, and the material of the adhesive layer 240 is an epoxy resin. The material of the soft substrate 231 is a metal, and the abrasive particles 232 are diamond particles with a diameter of about 130 μm. In addition, the thickness of the grinding plate 230 is in a range of about 0.15 mm to 0.25 mm, and the binder 220 is wax.

In the present embodiment, the flatness (the difference in height between the center and the outer circle, i.e. convexity, is about 40 μm) of the working surface of the grinding tool 200 is measured by Micro-Hite. Herein, the center of the grinding tool 200 is defined as 0 mm. The difference in height between the center and the outer circle of the grinding tool 200 (at 40 μm away from the center) is measured as about 39 μm to 47 μm (the difference between the maximum and the minimum values is 8 μm), and the difference in height between the center and the inner circle (at 20 μm away from the center) is measured as about 18 μm to 23 μm (the difference between the maximum and the minimum values is 5 μm). Accordingly, the flatness of the grinding tool 200 according to the present embodiment is examined.

Accordingly, by the method according to the present embodiment, the height of the abrasive particles can be precisely controlled, and thereby each of the abrasive particles can efficiently perform machining so as to enhance the machining efficiency and precision of the grinding tool. In addition, the method provided by the present embodiment can inhibit the precision errors caused by the thermal deformation of the backplane, and more kinds of materials can be used for the backplane. Herein, the backplane can be made of a material that can be easily machined and exhibit improved chemical resistance (in the present embodiment, the material of the backplane is stainless steel) and be less remaining stress instead of a commonly-used metallic material, so that the stability of the products can be enhanced. Furthermore, the backplane can be retained separate from the grinding plate until necessary. Accordingly, the production lead time and the specifications can be reduced. Besides, the backplane can be separated from the grinding plate so as to be recycled, and thereby the cost of production can be reduced.

### Embodiment 2

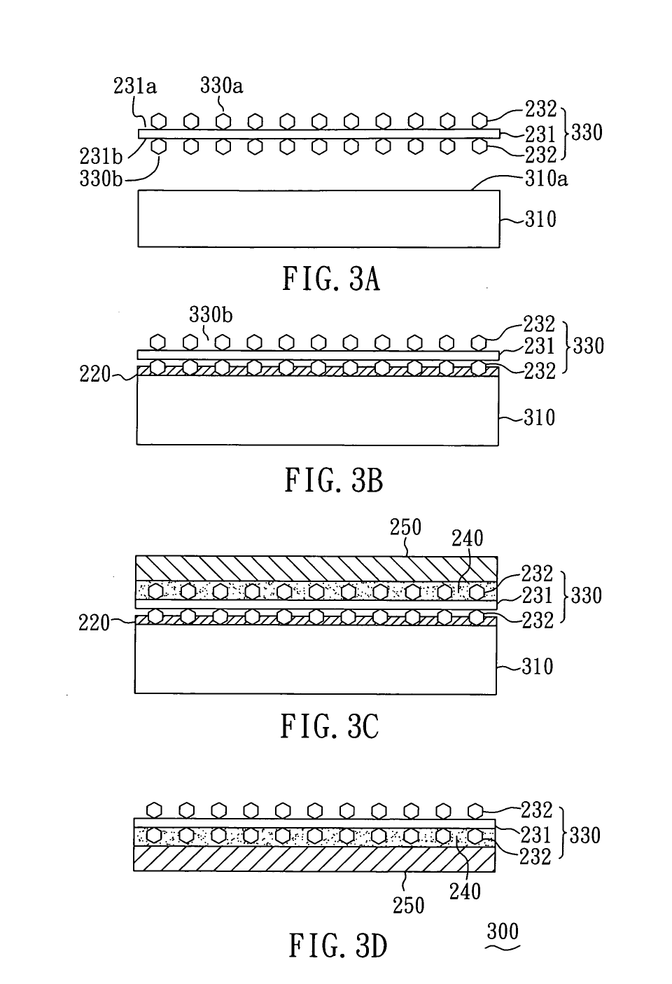

With reference to FIGS. 3A to 3D, there is shown a process for fabricating a grinding tool according to a preferred embodiment of the present invention. The manufacturing process provided by the present embodiment is the same as that described in Embodiment 1, except that the present embodiment uses a grinding plate with abrasive particles formed on two surfaces thereof and a mold with a flat adjustment surface.

As shown in FIG. 3A, a grinding plate 330 having a working surface 330a and a non-working surface 330b and a mold 310 with an adjustment surface 310a are first provided. Herein, the grinding plate 330 comprises: a soft substrate 231 having a working surface 231a and a non-working surface 231b and a plurality of abrasive particles 232 formed on the working surface 231a and the non-working surface 231b of the soft substrate 231 by brazing. In the present embodiment, the deformation resulting from the difference of shrinkage between the two surfaces of the soft substrate can be inhibited since the abrasive particles 232 are distributed over both surfaces of the soft substrate 231.

Subsequently, as shown in FIG. 3B, the adjustment surface of the mold 310 is coated with a binder 220, and then the working surface of the grinding plate 330 is attached and fits precisely on the adjustment surface of the mold 310, so that the abrasive particles 232 on the working surface of the grinding plate 330 can fit precisely on the adjustment surface of the mold 310. Next, the binder 220 is cured by a heating process (at a temperature of about 60° C.˜100° C.) to retain the grinding plate 330 on the mold 310 and ensure that the curvature of the working surface of the grinding plate 330 accords with that of the adjustment surface of the mold. Herein, the grinding plate 330 can fit precisely on the adjustment surface of the mold due to its flexibility so as to precisely control the precision of the grinding plate 330 and adjust the height of the abrasive particles 232. Accordingly, each of the abrasive particles 232 can efficiently perform machining so as to significantly enhance the machining efficiency and precision of the grinding tool and perform precision machining.

As shown in FIG. 3C, the non-working surface of the grinding plate 330 is coated with an adhesive layer 240 to form a flat surface. Then, a backplane 250 is disposed on the surface of the adhesive layer 240, and the adhesive layer 240 is cured by a heating process so as to retain the backplane 250 on the non-working surface of the grinding plate 330.

Finally, the binder is softened by a heating process (at a temperature of about 60° C.˜100° C.) and removed by washing to separate the mold 310 from the grinding plate 330. Accordingly, a grinding tool 300 is obtained, as shown in FIG. 3D.

In the present embodiment, the material of the backplane 250 is stainless steel, and the material of the adhesive layer 240 is an epoxy resin. The material of the soft substrate 231 is a metal, and the abrasive particles 232 are diamond particles with a diameter of about 130 μm. In addition, the thickness of the grinding plate 230 is in a range of about 0.15 mm to 0.25 mm, and the binder 220 is wax.

In the present embodiment, the flatness (the difference in height between the center and the outer circle, i.e. convexity, is about 0 μm) of the working surface of the grinding tool 360 is measured by Micro-Hite. Herein, the center of the grinding tool 300 is defined as 0 mm. The difference in height between the center and the outer circle of the grinding tool 300 (at 40 μm away from the center) is measured as about −2 μm to 9 μm (the difference between the maximum and the minimum values is 11 μm), and the difference in height between the center and the inner circle (at 20 μm away from the center) is measured as about −4 μm to 7 μm (the difference between the maximum and the minimum values is 11 μm). Accordingly, the flatness of the grinding tool 300 according to the present embodiment is examined.

Accordingly, by the method according to the present embodiment, a grinding tool with the characteristics described in Embodiment 1 can be obtained. In addition, the deformation resulting from the difference of shrinkage between the two surfaces of the soft substrate can be inhibited since the abrasive particles are distributed over both surfaces of the soft substrate.

### Embodiment 3

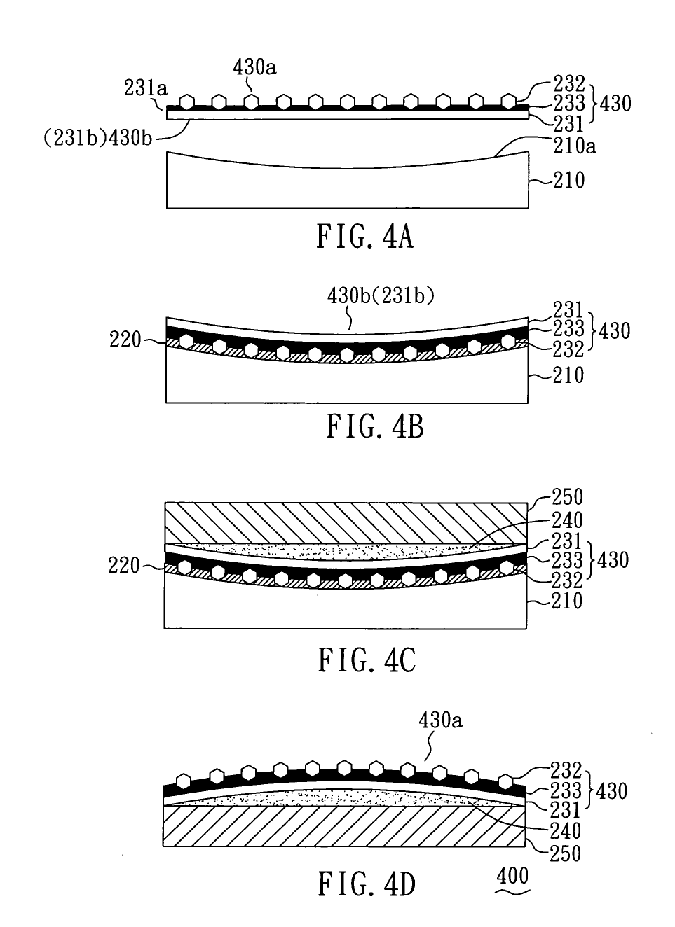

With reference to FIGS. 4A to 4D, there is shown a process for fabricating a grinding tool according to a preferred embodiment of the present invention. The manufacturing process provided by the present embodiment is the same as that described in Embodiment 1, except that the grinding player used in the present embodiment further comprises a combining layer.

As shown in FIG. 4A, a grinding plate 430 having a working surface 430a and a non-working surface 430b and a mold 210 with an adjustment surface 210a are first provided. Herein, the grinding plate 430 comprises: a soft substrate 231 having a working surface 231a and a non-working surface 231b; a combining layer 233 formed on the working surface 231a of the soft substrate 231; and a plurality of abrasive particles 232 formed on the surface of the combining layer 233 (in the present embodiment, the combining layer 233 is a metal layer) by brazing of metals.

Subsequently, as shown in FIG. 4B, the adjustment surface of the mold 210 is coated with a binder 220, and then the working surface of the grinding plate 430 is attached and fits precisely on the adjustment surface of the mold 210, so that the abrasive particles 232 on the working surface of the grinding plate 430 can fit precisely on the adjustment surface of the mold 210.Next, the binder 220 is cured by a heating process (at a temperature of about 60° C.˜100° C.) to retain the grinding plate 430 on the mold 210 and ensure that the curvature of the working surface of the grinding plate 430 accords with that of the adjustment surface of the mold. Herein, the grinding plate 430 can fit precisely on the adjustment surface of the mold due to its flexibility so as to precisely control the precision of the grinding plate 430 and adjust the height of the abrasive particles 232. Accordingly, each of the abrasive particles 232 can efficiently perform machining so as to significantly enhance the machining efficiency and precision of the grinding tool and perform precision machining.

As shown in FIG. 4C, the non-working surface of the grinding plate 430 is coated with an adhesive layer 240 to form a flat surface. Then, a backplane 250 is disposed on the surface of the adhesive layer 240, and the adhesive layer 240 is cured by a heating process so as to retain the backplane 250 on the non-working surface of the grinding plate 430.

Finally, the binder is softened by a heating process (at a temperature of about 60° C.˜100° C.) and removed by washing to separate the mold 210 from the grinding plate 430. Accordingly, a grinding tool 400 is obtained, as shown in FIG. 4D.

In the present embodiment, the material of the backplane 250 is stainless steel, and the material of the adhesive layer 240 is an epoxy resin. The material of the soft substrate 231 is a metal, and the abrasive particles 232 are diamond particles with a diameter of about 130 μm. In addition, the thickness of the grinding plate 430 is in a range of about 0.15 mm to 0.25 mm, and the binder 220 is wax.

Accordingly, by the method according to the present embodiment, the height of the abrasive particles can be precisely controlled, and thereby each of the abrasive particles can efficiently perform machining so as to enhance the machining efficiency and precision of the grinding tool. In addition, the method provided by the present embodiment can inhibit the precision errors caused by the thermal deformation of the backplane, and more kinds of materials can be used for the backplane. Herein, the backplane can be made of a material that can be easily machined and exhibit improved chemical resistance (in the present embodiment, the material of the backplane is stainless steel) and be less remaining stress instead of a common-used metallic material, so that the stability of the products can be enhanced. Furthermore, the backplane can be retained separate from the grinding plate until necessary. Accordingly, the production lead time and the specifications can be reduced. Besides, the backplane can be separated from the grinding plate so as to be recycled, and thereby the cost of production can be reduced.

### Embodiment 4

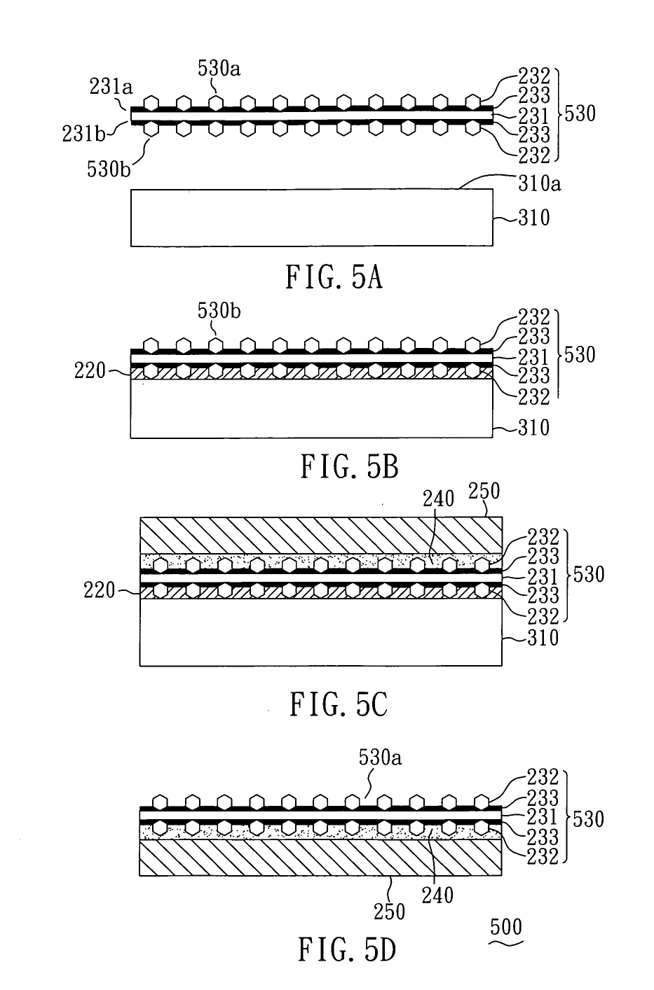

With reference to FIGS. 5A to 5D, there is shown a process for fabricating a grinding tool according to a preferred embodiment of the present invention. The manufacturing process provided by the present embodiment is the same as that described in Embodiment 2, except that the grinding player used in the present embodiment further comprises a combining layer on both surfaces thereof.

As shown in FIG. 5A, a grinding plate 530 having a working surface 530a and a non-working surface 530b and a mold 310 with an adjustment surface 310a are first provided. Herein, the grinding plate 530 comprises: a soft substrate 231 having a working surface 231a and a non-working surface 231b; a combining layer 233 formed on the working layer 231a and the non-working surface 231b of the soft substrate 231; and a plurality of abrasive particles 232 formed on the surface of the combining layer 233 (in the present embodiment, the combining layer 233 is a metal layer) by brazing of metals. In the present embodiment, the deformation resulting from the difference of shrinkage between the two surfaces of the soft substrate can be inhibited since both surfaces of the soft substrate 231 have abrasive particles 232 and a combining layer 233 thereon.

Subsequently, as shown in FIG. 5B, the adjustment surface of the mold 310 is coated with a binder 220, and then the working surface of the grinding plate 530 is attached and fits precisely on the adjustment surface of the mold 310, so that the abrasive particles 232 on the working surface of the grinding plate 530 can fit precisely on the adjustment surface of the mold 310.Next, the binder 220 is cured by a heating process (at a temperature of about 60° C.˜100° C.) to retain the grinding plate 530 on the mold 310 and ensure that the curvature of the working surface of the grinding plate 530 accords with that of the adjustment surface of the mold. Herein, the grinding plate 530 can fit precisely on the adjustment surface of the mold due to its flexibility so as to precisely control the precision of the grinding plate 530 and adjust the height of the abrasive particles 232. Accordingly, each of the abrasive particles 232 can efficiently perform machining so as to significantly enhance the machining efficiency and precision of the grinding tool and perform precision machining.

As shown in FIG. 5C, the non-working surface of the grinding plate 530 is coated with an adhesive layer 240 to form a flat surface. Then, a backplane 250 is disposed on the surface of the adhesive layer 240, and the adhesive layer 240 is cured by a heating process so as to retain the backplane 250 on the non-working surface of the grinding plate 530.

Finally, the binder is softened by a heating process (at a temperature of about 60° C.˜100° C.) and removed by washing to separate the mold 310 from the grinding plate 530. Accordingly, a grinding tool 500 is obtained, as shown in FIG. 5D.

In the present embodiment, the material of the backplane 250 is stainless steel, and the material of the adhesive layer 240 is an epoxy resin. The material of the soft substrate 231 is a metal, and the abrasive particles 232 are diamond particles with a diameter of about 130 μm. In addition, the thickness of the grinding plate 530 is in a range of about 0.15 mm to 0.25 mm, and the binder 220 is wax.

Accordingly, by the method according to the present embodiment, a grinding tool with the characteristics described in Embodiment 4 can be obtained. In addition, the deformation resulting from the difference of shrinkage between the two surfaces of the soft substrate can be inhibited since both surfaces of the soft substrate have abrasive particles and a combining layer thereon.

Although the present invention has been explained in relation to its preferred embodiment, it is to be understood that many other possible modifications and variations can be made without departing from the scope of the invention as hereinafter claimed.

What is claimed is:

1. A grinding tool, comprising:
a backplane;
an adhesive layer disposed on a surface of the backplane; and
a grinding plate disposed on a surface of the adhesive layer, wherein the grinding plate has a working surface and the working surface is exposed outside.

2. The grinding tool as claimed in claim 1, wherein the grinding plate comprises a soft substrate having a working surface and a non-working surface and a plurality of abrasive particles distributed over the soft substrate.

3. The grinding tool as claimed in claim 2, wherein the abrasive particles are distributed over the working surface of the soft substrate.

4. The grinding tool as claimed in claim 2, wherein the abrasive particles are distributed over the working surface and the non-working surface of the soft substrate.

5. The grinding tool as claimed in claim 2, wherein the grinding plate further comprises a combining layer disposed between the soft substrate and the abrasive particles.

6. The grinding tool as claimed in claim 5, wherein the combining layer is disposed on the working surface of the soft substrate and the abrasive particles are disposed on a surface of the combining layer.

7. The grinding tool as claimed in claim 5, wherein the combining layer is disposed on the working surface and the non-working surface of the soft substrate and the abrasive particles are disposed on a surface of the combining layer.

8. The grinding tool as claimed in claim 1, wherein the thickness of the grinding plate is in a range of about 0.15 mm to 0.25 mm.

9. The grinding tool as claimed in claim 2, wherein the abrasive particles are diamond particles and the diameter of the abrasive particles is in a range of about 80 μm to 300 μm.

10. The grinding tool as claimed in claim 2, wherein the material of the soft substrate is a metallic material or a plastic material.

11. The grinding tool as claimed in claim 2, wherein the material of the backplane is stainless steel.

12. The grinding tool as claimed in claim 1, wherein the material of the adhesive layer is an epoxy resin.

13. A method for fabricating a grinding tool, comprising:
(A) providing a grinding plate, a mold and a backplane, wherein the grinding plate has a working surface and a non-working surface and the mold has an adjustment surface;
(B) getting the working surface of the grinding plate to fit precisely and be retained on the adjustment surface of the mold by a binder;
(C) forming an adhesive layer on the non-working surface of the grinding plate;
(D) disposing the backplane on a surface of the adhesive layer to retain the backplane over the non-working surface of the grinding plate by the adhesive layer; and
(E) removing the binder to separate the mold from the grinding plate.

14. The method as claimed in claim 13, wherein the binder makes the working surface of the grinding plate fit precisely and be retained on the adjustment surface of the mold by a heating process in the step (B).

15. The method as claimed in claim 13, wherein the binder is removed by a heating and washing process in the step (E).

16. The method as claimed in claim 13, wherein the grinding plate comprises a soft substrate having a working surface and a non-working surface and a plurality of abrasive particles distributed over the soft substrate, and the abrasive particles are diamond particles.

17. The method as claimed in claim 16, wherein the abrasive particles are distributed over the working surface of the soft substrate.

18. The method as claimed in claim 16, wherein the abrasive particles are distributed over the working surface and the non-working surface of the soft substrate.

19. The method as claimed in claim 16, wherein the grinding plate further comprises a combining layer disposed between the soft substrate and the abrasive particles.

20. The method as claimed in claim 19, wherein the combining layer is disposed on the working surface of the soft substrate and the abrasive particles are disposed on a surface of the combining layer.

21. The method as claimed in claim 19, wherein the combining layer is disposed on the working surface and the non-working surface of the soft substrate and the abrasive particles are disposed on a surface of the combining layer.
